(19) United States
(12) Patent Application Publication
(10) Pub. No.: US 2014/0266977 A1
(43) Pub. Date: Sep. 18, 2014

(54) POLARIZATION CONVERTING DIELECTRIC PLATE

(71) Applicant: WAVECONNEX, INC., MOUNTAIN VIEW, CA (US)

(72) Inventor: Justin Redd, Portland, OR (US)

(21) Appl. No.: 14/217,009

(22) Filed: Mar. 17, 2014

Related U.S. Application Data
(60) Provisional application No. 61/799,548, filed on Mar. 15, 2013.

(51) Int. Cl. H01Q 15/24

(52) U.S. Cl. CPC H01Q 15/244
USPC 343/911 R

(57) ABSTRACT

A dielectric plate for use with a source of electromagnetic radiation of a predetermined frequency propagating along a propagation path is provided. The dielectric plate may include alternating elongate parallel first and second dielectric elements and a frame supporting the first and second dielectric elements distributed in a first plane. The electromagnetic radiation may be predominantly linearly polarized parallel to the first plane. The first plane of the dielectric plate may transverse to the second plane and the propagation path may pass through the dielectric plate when the dielectric plate is supported in the propagation path of the electromagnetic radiation. The first and second dielectric elements may have different dielectric constants and respective thicknesses along the propagation path so that the electromagnetic radiation that passes through the first dielectric elements may be phase shifted by a predetermined amount from the electromagnetic radiation that passes through the second dielectric elements.

### CROSS-REFERENCES TO RELATED APPLICATION

The present application claims the benefit under 35 U.S.C. §119(e) of U.S. Provisional Patent Application Ser. No. 61/799,548 for BIREFRINGENT DIELECTRIC CIRCULAR POLARIZER , filed Mar. 15, 2013, which is hereby incorporated by reference in its entirety for all purposes.

### TECHNICAL FIELD

The disclosure relates to the field of polarization. More particularly, the disclosure relates to converting linearly polarized electromagnetic radiation to circularly polarized electromagnetic radiation.

### BACKGROUND

Many radio-frequency antennas produce electromagnetic radiation that is predominantly linearly polarized. When a device, such as a receiving antenna, is positioned to receive linearly polarized electromagnetic radiation, orientation of the receiving antenna relative to the transmitted electromagnetic radiation is important for receiving a strong signal.

Conventionally, quarter-wave plates may be used to convert linearly polarized electromagnetic radiation into circularly polarized radio frequency electromagnetic radiation. The quarter-wave plates are constructed using specific materials that have been found to possess birefringent properties in which electromagnetic radiation passing through the material propagate at different rates depending on the relative angle of the radiation relative to the birefringent material. Examples of material known to have birefringent properties include quartz, mica and the like. However, quarter-wave plates made of birefringent materials tend to be bulky and can be difficult to be implemented in a small form factor integrated chip package.

### BRIEF SUMMARY

In a first example, a dielectric plate for use with a source of electromagnetic radiation of a predetermined frequency propagating along a propagation path is provided. The dielectric plate may include a plurality of alternating elongate parallel first and second dielectric elements and a frame supporting the first and second dielectric elements distributed in a first plane. The electromagnetic radiation may be predominantly linearly polarized parallel to the first plane. The first plane of the dielectric plate may transverse to the second plane and the propagation path may pass through the dielectric plate when the dielectric plate is supported in the propagation path of the electromagnetic radiation. The first and second dielectric elements may have different dielectric constants and respective thicknesses along the propagation path so that the electromagnetic radiation that passes through the first dielectric elements may be phase shifted by a predetermined amount from the electromagnetic radiation that passes through the second dielectric elements.

In a second example, a method of altering radiation may include directing a first portion of electromagnetic radiation propagating along a propagation path and concurrently directing a second portion of the electromagnetic radiation through a set of plural elongate parallel second dielectric elements interleaved with the set of first dielectric elements. The electromagnetic radiation may be predominantly linearly polarized parallel to a first plane through a set of plural elongate parallel first dielectric elements distributed in a second plane transverse to the first plane. The set of second dielectric elements may be distributed in the second plane. The first and second dielectric elements may have different dielectric constants and respective thicknesses along the propagation path so that the first portion of the electromagnetic radiation passes through the first dielectric elements at a sufficiently different rate of propagation than the second portion of the electromagnetic radiation passes through the set of second dielectric elements. The first portion of electromagnetic radiation may be phase shifted by a predetermined amount relative to the second portion of electromagnetic radiation.

### BRIEF DESCRIPTION OF THE DRAWINGS

Having thus described the invention in general terms, reference will now be made to the accompanying drawings, which are not necessarily drawn to scale, and wherein:

FIG. 1 illustrates an isometric view of a first example of a dielectric plate for changing linearly polarized electromagnetic radiation to circularly polarized electromagnetic radiation;

FIG. 2 illustrates an isometric view of a second example of a dielectric plate;

FIG. 3 illustrates a top view of the dielectric plate of FIG. 1;

FIG. 4 is a cross-sectional view taken along line 4-4 in FIG. 3;

FIG. 5 illustrates a phase shift produced in electromagnetic radiation by the dielectric plate of FIGS. 1 and 2;

FIG. 6 illustrates conceptually how a dielectric plate of FIG. 1 or 2 may be oriented relative to a horn antenna for producing circularly polarized electromagnetic radiation;

FIG. 7 illustrates a radiation-altering assembly including a horn antenna and a dielectric plate of FIG. 1 or 2; and

FIG. 8 illustrates a flowchart for altering the polarization of the electromagnetic radiation.

There may be additional structures described in the description that are not depicted in the drawings, and the absence of such a drawing should not be considered as an omission of such design from the specification.

### DETAILED DESCRIPTION

FIG. 1 illustrates an isometric view of a dielectric plate 100 for changing linearly polarized electromagnetic radiation 102 traveling along a propagation path 104, illustrated by arrows, into circularly polarized electromagnetic radiation 106. In this example, the electromagnetic radiation 102 incident on plate 100 is predominantly linearly polarized in a plane 108. The dielectric plate 100 may include a frame 110, which supports a plurality of first dielectric elements 112 and a plurality of second dielectric elements 114. In this example, dielectric elements 112 are a gas, such as ambient air, and dielectric elements 114 are made of a solid dielectric element, such as a thermoplastic polymer. Some examples of thermoplastic polymers include, but are not limited to acrylics, nylon, polyethylene and polystyrene. It will be appreciated, then that the dielectric elements may be any suitable combination of dielectric mediums, including solids, liquids, and gases. Each dielectric element may also be formed of layers of different dielectric materials.

The frame supports the dielectric elements along a plane 116 of a face 118 of the dielectric plate. Radiation plane 108 is orthogonal to plate plane 116 in this example. As will be discussed further, dielectric elements 108 and 110 are elongate and parallel in plate plane 116 and extend in that plane transverse to radiation plane 116. The dielectric elements also have a thickness T along radiation path 104 and have respective dielectric constants that are sufficiently different that orthogonal components of electromagnetic radiation linearly polarized in plane 108 travel through the dielectric elements at different rates, producing circularly polarized radiation 106 exiting the dielectric plate, FIG. 2 illustrates a second example of a circularly polarizing dielectric plate 200. Plate 200 may circularly polarize linearly polarized radiation, as described for dielectric plate 100. However, in this example dielectric plate 200 may be formed of solid dielectric elements 202 and 204 supported by a frame 206. The plurality of the first dielectric elements 202 and the second dielectric elements 204 may be distributed alternatingly in the frame 206.

The dielectric constant of the first dielectric elements 202 may be lower than the dielectric constant of the second dielectric elements 204. This difference in the dielectric constants of the first and second dielectric elements is preferably sufficient to produce differential rates of propagation of electromagnetic radiation of transverse orientations through them. In addition, the thicknesses of the first dielectric elements 102 and the second dielectric elements 104 along with the difference in the dielectric constants may enable the change in polarization of electromagnetic radiation from linear polarization to circular polarization as discussed with reference to dielectric plate 100 and as further explained below.

FIG. 3 is a plan or top view of dielectric plate 100, it being understood that the features described also apply to dielectric plate 200. The plane of the view corresponds to plate plane 116. Plane 108 of the incident linearly polarized radiation is normal to plane 116. Propagation path 104 extends along plane 108 and is orthogonal to plane 116. It is seen that the dielectric elements are elongate in plane 116 and extend parallel to a line 120. The plane of polarization of the incident radiation is transverse to the line of the dielectric elements and intersects the face of the dielectric plate at an angle A. In this example, angle A is 45 degrees, although other angles may be used, so long as the plane of radiation polarization is transverse to the line of the dielectric elements.

FIG. 4 is a cross-section taken along line 4-4 in FIG. 3. The cross-section is orthogonal to the lengths of the dielectric elements. In this example, the dielectric elements have rectangular cross sections having thickness T along the path 104 of radiation propagation. Dielectric elements 112 have a width W1 and dielectric elements 114 have a width W2. Widths W1 and W2 in this example are the same.

In this example, then, the cross-sections of the first dielectric elements 102 and the second dielectric elements 104 normal to their respective lengths may be equal. In some examples, the dielectric elements may be more than twice as thick as they are wide. In yet other examples, the widths W1 and W2 may be less than or equal to 20% of the wavelength of a predetermined frequency of the incident electromagnetic radiation.

FIG. 5 illustrates a phase shift produced by the dielectric plates 100 and 200 in the electromagnetic radiation traversing the dielectric plates. The linearly polarized electromagnetic radiation may be composed of many electromagnetic waves that combine to produce the resultant linear polarization. A portion of the linearly polarized electromagnetic radiation may pass through the first dielectric elements 112 and another portion of the linearly polarized electromagnetic radiation may pass through the second dielectric elements 114. As mentioned above, the first dielectric elements 112 may be air slots having a dielectric constant of 1 and the second dielectric elements 114 may be made of a solid dielectric material having moderate significantly higher dielectric constant. Thus, the portion of the linear polarized electromagnetic radiation passing through the first dielectric elements 112 may be quarter wavelength, corresponding to a phase shift of 90 degrees, ahead of the portion of the linear polarized electromagnetic radiation passing through the second dielectric elements 114. The dielectric plate may also be configured to provide other amounts of relative phase shift between the two radiation components travelling through the dielectric plate at different rates. In a specific example, shown in FIG. 6, a horn antenna 602 enclosed in a supporting frame or casing 604 of a radiation-altering assembly 600 may feed linearly polarized electromagnetic radiation 606 to a dielectric plate 608 made as described for dielectric plates 100 and 200. The dielectric plate 608 may be positioned in a radiation propagation path 612 for converting the linearly polarized electromagnetic radiation to circularly polarized electromagnetic radiation. The horn antenna 602 may receive the electromagnetic radiation from a source and may direct the linearly polarized electromagnetic radiation to the dielectric plate 608. The horn antenna 602 may have a rectangular aperture 610. The rectangular aperture 610 may direct the linear polarized electromagnetic radiation 606 along a propagation path indicated by propagation axis 612 normal to the plane of the aperture 606. The horn antenna 602 may include a waveguide 614, a metallic horn 616 defining the aperture 610. The waveguide 614 may feed the metallic horn 616 with the electromagnetic radiation. Further, the metallic horn may direct the electromagnetic radiation along propagation axis 612. The propagation axis may correspond to an axis of symmetry of the horn antenna 602. This linearly polarized electromagnetic radiation propagating along the propagation axis may be circularly polarized by the dielectric plate 608.

It may be noted that the horn antenna 602 is shown to feed the linearly polarized electromagnetic radiation to the dielectric plate 608; however, those skilled in the art will appreciate that linearly polarized electromagnetic radiation may be fed to the dielectric plate from any other linearly polarized radiation source.

FIG. 7 illustrates a yet further example of a radiation altering assembly 700 having the functionality described for radiation altering assembly 600. In this specific example, a horn antenna 702 is enclosed in a supporting frame or casing 704 may feed linearly polarized electromagnetic radiation to a dielectric plate 706 made as described for dielectric plates 100 and 200. The dielectric plate 706 may be positioned in a radiation propagation path for converting the linearly polarized electromagnetic radiation to circularly polarized electromagnetic radiation. The casing 704 may be provided to support the horn antenna 702 and the dielectric plate 706. In this example, casing 704 may also support a collimating lens 708.

FIG. 8 is a flowchart 800 illustrating a method for altering the polarization of the electromagnetic radiation. The flowchart 800 initiates at step 802. At step 804, as mentioned above, a first portion of the electromagnetic radiation propagating along a propagation path may be directed through a set of plural elongate parallel first dielectric elements. At step 806, the second portion of the electromagnetic radiation may be concurrently directed through a set of plural elongate parallel second dielectric elements interleaved with the set of the first dielectric elements. The first dielectric elements and the second dielectric elements may have different dielectric constants and respective thicknesses along the propagation path. So, the first portion of the electromagnetic radiation passing through the first dielectric elements may propagate at a sufficiently different rate of propagation than the second portion of the electromagnetic radiation passing through the set of second dielectric elements to produce a relative phase shift between the two portions. Moreover, the first portion of the electromagnetic radiation may be phase shifted by a predetermined amount relative to the second portion of the electromagnetic radiation. At step 708, the set of the first dielectric elements and the set of the second dielectric elements may be oriented to extend the lengths of the first dielectric element and the second dielectric elements at an angle of forty-five degrees to the first plane. As described above, the orientation the first dielectric elements and the second dielectric elements may introduce a phase shift of a quarter wavelength corresponding to a phase shift of ninety degrees, thereby producing circularly polarized electromagnetic radiation. The method 800 terminates at step 810.

The dielectric plate describe above in the disclosure has many advantages. The dielectric plate is not bulky. In addition, the dielectric plate can be easily implemented in a small form factor integrated chip package, thereby reducing the overall complexities.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

What is claimed is:

1. A dielectric plate for use with a source of electromagnetic radiation of a predetermined frequency propagating along a propagation path, the electromagnetic radiation being predominantly linearly polarized parallel to a first plane; the dielectric plate comprising a plurality of alternating elongate parallel first and second dielectric elements and a frame supporting the first and second dielectric elements distributed in a first plane, the dielectric plate, when supported in the propagation path of the electromagnetic radiation with the first plane transverse to the second plane and the propagation path passes through the dielectric plate, the first and second dielectric elements having different dielectric constants and respective thicknesses along the propagation path so that the electromagnetic radiation that passes through the first dielectric elements is phase shifted by a predetermined amount from the electromagnetic radiation that passes through the second dielectric elements.

2. The dielectric plate of claim 1, wherein the first dielectric elements are made of a solid material and the second dielectric elements are air.

3. The dielectric plate of claim 2, wherein the first dielectric elements are made of an insulating thermoplastic polymer.

4. The dielectric plate of claim 1, wherein when the first plane is positioned normal to the propagation path, the second plane intersects the first plane along a first line and the first and second dielectric elements extend in the first plane along lines that intersect the first line at an angle of 45-degrees.

5. The dielectric plate of claim 1, wherein the first and second dielectric elements have respective thicknesses along the path of propagation for phase shifting radiation that passes through the first dielectric elements one-quarter of a wavelength of the predetermined frequency from radiation that passes through the second dielectric elements.

6. The dielectric plate of claim 1, wherein the first and second dielectric elements have rectangular cross-sections normal to the lengths of the first and second dielectric elements.

7. The dielectric plate of claim 6, wherein the cross-sections of the first and second dielectric elements normal to the lengths of the first and second dielectric elements are more than twice as long in a dimension parallel to the propagation path as the dimension in the first plane.

8. The dielectric plate of claim 1, wherein the cross-sections of the first and second dielectric elements normal to the lengths of the first and second dielectric elements are the same size.

9. The dielectric plate of claim 1, wherein the widths of the cross-sections of the first and second elements normal to the lengths of the first and second dielectric elements and normal to the first plane are less than or equal to 20% of the wavelength of the predetermined frequency.

10. A method of altering radiation comprising:
directing a first portion of electromagnetic radiation propagating along a propagation path, the electromagnetic radiation being predominantly linearly polarized parallel to a first plane through a set of plural elongate parallel first dielectric elements distributed in a second plane transverse to the first plane; and
concurrently directing a second portion of the electromagnetic radiation through a set of plural elongate parallel second dielectric elements interleaved with the set of first dielectric elements, the set of second dielectric elements also being distributed in the second plane, with the first and second dielectric elements having different dielectric constants and respective thicknesses along the propagation path so that the first portion of the electromagnetic radiation passes through the first dielectric elements at a sufficiently different rate of propagation than the second portion of the electromagnetic radiation passes through the set of second dielectric elements that the first portion of electromagnetic radiation is phase shifted by a predetermined amount relative to the second portion of electromagnetic radiation.

11. The method of claim 10, further comprising orienting the sets of first and second dielectric elements so their lengths in the second plane extend at an angle of 45 degrees to the first plane.
